(19) United States
(12) Patent Application Publication
(10) Pub. No.: US 2019/0313644 A1
(43) Pub. Date: Oct. 17, 2019

(54) METHOD FOR FRUIT THINNING

(71) Applicant: Adama Agan Ltd., Ashdod (IL)

(72) Inventors: Ton Besseling, Rossum (NL); Joan Bonany, Jafre (ES); Guglielmo Costa, Bologna (IT)

(73) Assignee: Adama Agan Ltd., Ashdod (IL)

(21) Appl. No.: 16/275,499

(22) Filed: Feb. 14, 2019

Related U.S. Application Data
(63) Continuation of application No. 15/745,331, filed on Jan. 16, 2018, now abandoned.
(60) Provisional application No. 62/361,760, filed on Jul. 13, 2016.
(60) Provisional application No. 62/194,006, filed on Jul. 17, 2015.

(51) Int. Cl. A01N 43/707; A01N 25/00

(52) U.S. Cl. CPC A01N 43/707; A01N 25/00

(57) ABSTRACT

Methods of fruit thinning fruit bearing plants using photosynthesis inhibiting fruit thinning agents are disclosed. Methods of determining the amount and/or timing of a first dose of photosynthesis inhibiting fruit thinning agents to be applied to a fruit bearing plant to thin fruit on the plant are disclosed. Methods of determining whether a second application of photosynthesis inhibiting fruit thinning agent is required to be applied to thin fruit on the plant, and if so the amount and/or timing thereof, are also disclosed. Methods of determining whether a dose of a photosynthesis inhibiting fruit thinning agent is required to be applied to a fruit bearing plant to thin fruit on the plant.

### FIELD

The present subject matter relates to a method for fruit thinning a fruit bearing plant.

### BACKGROUND

Thinning is considered to be an extremely important economic measure in pome fruit growing and in the commercial cultivation of other fruit crops. Thinning relates to the reduction in number of the pistillate flowers or of the number of fruit by mechanical means (by machine or hand) or by chemical thinning agents. Fruit thinning allows for an improved fruit size, color and/or quality and substantially improve profitability of the orchard. Fruit thinning may further allow for (i) improvement of flowering in a year subsequent to a year with fruitful flowering, (ii) breaking and preventing biennial bearing in endangered varieties and young plantations, (iii) avoiding the breaking of overloaded branches, (iv) avoiding pronounced exhaustion of the plant and (v) the associated reduced low-temperature resistance of the plant.

Thinning by hand is not an option in most growing regions owing to the costs involved. Thinning with machines is possible to a limited extent only, due to the difficulty of providing effective thinning while avoiding damage to the plant.

The use of photosynthesis inhibiting chemical thinning agents is described in U.S. Pat. No. 8,826,587 and Byers et al. (1990), which are hereby incorporated by reference.

Consistent and controlled thinning is especially critical in fruit bearing plants, where each fruit competes for resources from the tree. Too high of a fruit set on individual plants drastically reduces the size of each fruit and so reduces the sizing grade of the crop.

In general, it is very difficult for farmers to determine whether or not chemical thinning agents should be used, and if so, the amount and timing thereof, because many factors affect the final fruit load during and after the spraying season. It is also difficult to determine the efficacy of the first application of the fruit thinning agent, due to a large U.S. Ser. No. 16/275,499; Adama Agan Ltd.; Filing Date: Feb. 14, 2019; Exhibit D number of factors affecting the development of a fruit bearing plant, and as such the growth of the fruit on the plant. Fruit thinning agents may only be applied to the fruit bearing plant during a specific development stage of the fruit. A thinning agent applied too late may not only fail to thin, but may also stunt the growth of the fruit.

As such, it is critical to quickly determine the efficacy of the first application of the fruit thinning agent and to quickly decide if a second treatment is needed and in what dosage.

### SUMMARY

In an embodiment, the invention provides a method of fruit thinning a fruit bearing plant, comprising:
(i) applying an amount of a first dose of a photosynthesis inhibiting fruit thinning agent to a fruit bearing plant;
(ii) determining whether a second dose of the photosynthesis inhibiting fruit thinning agent needs to be applied, and if so the calculated amount of such dose, based on measurement at a time after the application of the first dose of the photosynthetic activity of the fruit bearing plant, and
(iii) if needed, applying the calculated second dose of the photosynthesis inhibiting fruit thinning agent, thereby fruit thinning the fruit bearing plant.

In another embodiment, the invention provides a method of fruit thinning a fruit bearing plant, comprising:
(i) applying a first dose of a photosynthesis inhibiting fruit thinning agent to a fruit bearing plant;
(ii) determining whether a second dose of the photosynthesis inhibiting fruit thinning agent needs to be applied, and if so the calculated amount and timing of such dose, based on
   a) measurement at a time after the application of the first dose of the photosynthetic activity of the fruit bearing plant; and
   b) meteorological data from the time of application of the first dose and the forecast of impending meteorological data affecting the fruit bearing plant; and
(iii) if needed, applying the calculated second dose of the photosynthesis inhibiting fruit thinning agent, thereby fruit thinning the fruit bearing plant.

In another embodiment, the invention provides a method of fruit thinning a fruit bearing plant, comprising:
(i) applying a first dose of a photosynthesis inhibiting fruit thinning agent to a fruit bearing plant;
(ii) measuring at a time after the application of the first dose at least the photosynthetic activity of the fruit bearing plant;
(iii) obtaining meteorological data from the time of application of the first dose and the forecast of impending meteorological data;
(iv) determining whether a second dose of the photosynthesis inhibiting fruit thinning agent is needed based on both the measurement obtained in step (ii) and the meteorological data obtained in step (iii), and if needed, calculating the amount and timing of the second dose; and
(v) if needed, applying the calculated second dose of the photosynthesis inhibiting fruit thinning agent, thereby fruit thinning the fruit bearing plant.

In another embodiment, the invention provides a method of determining the amount of a first dose of a photosynthesis inhibiting fruit thinning agent required to be applied to a fruit bearing plant to thin fruit on the plant comprising:
(i) obtaining meteorological data affecting the fruit bearing plant, and
(ii) determining the amount of the first dose based on the meteorological data obtained in step (i).

In another embodiment, the invention provides a method of determining whether a second dose of a photosynthesis inhibiting fruit thinning agent is required to be applied to a fruit bearing plant to thin fruit on the plant, and if so, the amount and timing thereof, comprising:
(i) obtaining a measurement of photosynthetic activity of the fruit bearing plant following the application of a first dose of a photosynthesis inhibiting fruit thinning agent to the fruit bearing plant;
(ii) obtaining meteorological data from the time of application of the first dose and the forecast of impending meteorological data; and
(iii) determining whether a second dose of the photosynthesis inhibiting fruit thinning agent is needed based on both the measurement obtained in step (i) and the meteorological data obtained in step (ii).

In another embodiment, the invention provides a method of determining whether a second dose of a photosynthesis inhibiting fruit thinning agent is required to be applied to a fruit bearing plant to thin fruit on the plant, and if so, the amount and timing thereof, comprising:
(i) obtaining a measurement of photosynthetic data of the fruit bearing plant following the application of a first dose of the photosynthesis inhibiting fruit thinning agent; and
(ii) determining whether a second dose of the photosynthesis inhibiting fruit thinning agent should be applied to the fruit bearing plant.

In another embodiment, the invention provides a method of determining whether a dose of a photosynthesis inhibiting fruit thinning agent is required to be applied to a fruit bearing plant to thin fruit on the plant comprising:
(i) obtaining meteorological data affecting the fruit bearing plant and/or a measurement of photosynthetic activity of the fruit bearing plant, and
(ii) determining whether a dose of a photosynthesis inhibiting fruit thinning agent is required based on the meteorological data and/or photosynthetic activity obtained in step (i).

### BRIEF DESCRIPTION OF THE DRAWINGS

FIG. 1 is a flow diagram illustrating a method of fruit thinning a fruit bearing plant.

FIG. 2 illustrates the evaluation results of the first application of a fruit thinning agent.

### TERMS

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.”

For purposes of better understanding the present teachings and in no way limiting the scope of the teachings, unless otherwise indicated, use of the term “about” or “approximately” herein specifically includes ±10% from the indicated values in the range. In addition, the endpoints of all ranges directed to the same component or property herein are inclusive of the endpoints, are independently combinable, and include all intermediate points and ranges.

As used herein, the term “fruit bearing plant” refers to any plant that produces fruit. Fruit bearing plants may include fruit bearing trees (such as apple, pear, quince, nut, and citrus trees), fruit bearing bushes (such as strawberry, raspberry, blackberry, and blueberry bushes), and fruit bearing vines and ground covers (such as melon, cucumber, and grape vines).

As used herein, “photosynthesis inhibiting fruit thinning agent” refer to an agent applied to fruit-producing plants which results in inhibition of photosynthesis in the plant and also results in a reduction in the number of pollinated flowers and/or fruits produced by the plant. Specific photosynthesis inhibiting fruit thinning agents, such as metamitron, chloroxuron, fluometuron, cyanazine, terbacil, simazine, propazine, terbutryn, dipropetryn, metribuzin, diuron, and bentazon, are described in U.S. Pat. No. 8,826,587 and Byers et al. (1990), the contents of each of which are hereby incorporated by reference.

BBCH numbers, such as BBCH71 and BBCH72, are references to the BBCH scale disclosed in “Growth stages of mono- and dicotyledonous plants” by the Federal Biological Research Centre for Agriculture and Forestry (2001), the contents of which are hereby incorporated by reference.

References to “calculating a second dose” and similar phrases are understood to also encompass calculating a range of second doses.

Embodiments will hereinafter be described in detail below with reference to the accompanying drawings, wherein like reference numerals represent like elements. The accompanying drawings have not necessarily been drawn to scale. Any values illustrated in the accompanying graphs and figures are for illustration purposes only and may not represent actual or preferred values. Where applicable, some features may not be illustrated to assist in the description of underlying features.

### DETAILED DESCRIPTION

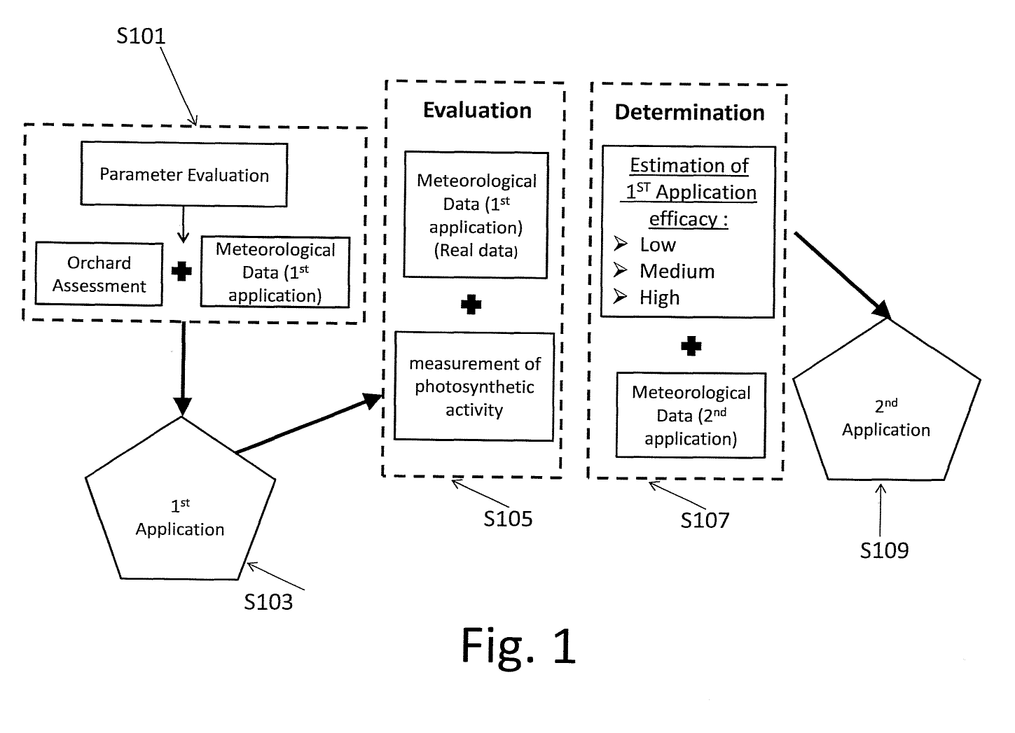

With reference to FIG. 1, in step S101 prior to applying a first dose of the photosynthesis inhibiting fruit thinning agent, a number of parameters may be evaluated. These parameters may be evaluated to determine the time of the application of the first dose and the amount of the first dose to be applied. A first set of parameters may include assessing the overall status of the orchard. This may include but is not limited to the size of the fruit, blooming intensity of the fruit, quality of the flower buds, age of the wood, level of vigor, age of tree, crop load, competition within clusters and canopy cover.

A second set of parameters may comprise meteorological data. The meteorological data may include but is not limited to a multi-day weather forecast of daytime temperatures, nighttime temperatures, amount of sunlight, cloud cover and humidity. Preferably, the meteorological data will include average nighttime temperature, maximum daily temperature, minimum daily temperature, and/or daily radiation. In one embodiment, the nighttime temperature is the average hourly temperature between 7 pm to 7 am. In one embodiment the meteorological data will include average nighttime temperature and average daily radiation. In another embodiment, the meteorological data will include maximum daily temperature, minimum daily temperature, and daily radiation. A multi-day weather forecast may include a weather forecast of at least one day, at least 2 days, at least 3 days, at least four days, at least 7 days or more. Preferably, the multi-day weather forecast includes a weather forecast of at least 7 days.

According to an embodiment, the multi-day forecast may include a period of time before and/or after the first application of the fruit thinning agent. For example, the weather forecast may include one to two days preceding the first application and/or one to two days after the first application. Preferably, the multi-day weather forecast includes a weather forecast of 3 days or 5 days prior to the application of the first dose. In one embodiment, the multi-day weather forecast includes the weather forecast for the 7th, 6th, and 5th day prior to the application of the first dose. In another embodiment, the multi-day weather forecast includes the weather forecast for the 6th, 5th, and 4th day prior to the application of the first dose.

In another embodiment, the meteorological data includes a multi-day forecast of average nightly temperature and average daily radiation over a period of 3 days prior to the application of the first dose. In yet another embodiment, wherein the meteorological data includes a multi-day forecast of maximum daily temperature, minimum daily temperature, and daily radiation over a period of 3 days prior to the application of the first dose.

The multi-day forecast may also include a period of time before and/or after the second application of the fruit thinning agent. Preferably, the multi-day weather forecast includes a weather forecast of 3 days or 5 days prior to the application of the second dose.

According to a preferred embodiment, the meteorological data from the time of the first application comprises meteorological data from the 8^{th}, 7^{th}, 6^{th}, 5^{th} and 4^{th} day prior to the application of the second dose. In another preferred embodiment, the meteorological data from the time of the first application comprises meteorological data from the 7^{th}, 6^{th}, 5^{th}, 4^{th}, and 3^{nd} day prior to the application of the second dose. In one embodiment, the meteorological data includes a multi-day forecast of average nightly temperature and average daily radiation over a period of 5 days prior to the application of the second dose. In one embodiment, the meteorological data includes a multi-day forecast of maximum daily temperature, minimum daily temperature, and daily radiation over a period of 5 days prior to the application of the second dose.

Meteorological data may be used to evaluate the carbohydrate balance of the fruit bearing plant. Generally, the demand of carbohydrate in a fruit bearing tree is mainly related to temperature, fruit size, growth power of shoots, and tree variety. The supply of carbohydrate in a fruit bearing tree is mainly related to radiation. Many models have been established to evaluate the carbohydrate balance of the fruit bearing plant. In order to determine the amount and/or the time of application of the first and/or second application of the fruit thinning agent, one or more of these carbohydrate balance models may be used. The input variables used in these models may also be used, either separately or in any combination, to determine the amount and/or time of application of the first and/or second application of the fruit thinning agent even if the entire model is not used.

Last year's reserve of dry matter in the fruit bearing tree may also be used to evaluate the carbohydrate balance of the fruit bearing plant. None of the currently available carbohydrate balance models use last year's reserve of dry matter for evaluating carbohydrate balance. Generally, there is less reserve from the previous year if there has been heavy crop production in the previous year and/or if the preceding winter was relatively warm.

Some examples of known carbohydrate balance models that may be used to determine the amount and/or time of application of the first and/or second application of the fruit thinning agent includes the MaluSim model, the Ag-Radar model, and the Clever model. The MaluSim model has been described in Robinson, T. L. and A. N. Lakso, New York Fruit Quaterly Vol. 19(1): 15-20 (2011), which is hereby incorporated by reference. The MaluSim model calculates dry matter production and consumption in the fruit bearing plant based primarily on photosynthesis level and leaf area, and it is discussed in more detail on page 11, infra. The Ag-Radar model and the Clever model calculates dry mass production based primarily on daily radiation and temperature.

Upon completion of the evaluation, the amount of photosynthesis inhibiting fruit thinning agent to be applied on the fruit bearing plant may be determined. As is known in the art, the amount of fruit thinning agent to be applied may be derived from the product label which may be largely based on the hereinabove parameters. According to an embodiment, the first dose S103 of the fruit thinning agent may be applied at a rate of approximately 0.05 to 4 kg/ha. Persons having ordinary skill in the art will appreciate that the maximum amount of 4 kg/ha is a total amount for two or more active ingredients, and that the amounts in the following embodiments are the preferred amounts for one active ingredient. In one embodiment, the application rate of the first dose may be approximately 0.05 to 2.5 kg/ha. In another embodiment, the application rate of the first dose may be approximately 0.05 to 2.2 kg/ha. In another embodiment, the application rate of the first dose may be approximately 0.75 to 2.5 kg/ha. In a further embodiment, the application rate of the first dose may be approximately 1.1 to 2.2 kg/ha. In one embodiment, the application rate of the first dose may be approximately 1.1 kg/ha. In another embodiment, the application rate of the first dose may be approximately 1.65 kg/ha. In another embodiment, the application rate of the first dose may be approximately 2.2 kg/ha.

According to an embodiment, the application rate of water for the fruit thinning agent may vary. The application rates of the fruit thinning agent cannot generally be defined, as it varies depending upon various conditions such as the type of the formulation, and their concentration in the formulations. In one embodiment, the application rate may be 100 l/ha to 1500 l/ha. In an embodiment, the application rate may be 500 to 1500 l/ha. In an embodiment, the application rate may be 500-1000 l/ha. In an embodiment, the application rate may be 1000-1500 l/ha. In an embodiment, the application rate may be approximately 500 l/ha, 750 l/ha, 1000 l/ha, 1250 l/ha, or 1500 l/ha. Preferably, the application rate is 1000 l/ha. However, lower water application rates of 100 to 500 l/ha may also be used in certain embodiments. In one embodiment, the application rate may be 100 to 500 l/ha, 200 to 500 l/ha, 300 to 500 l/ha, or 400 to 500 l/ha. Preferably, the application rate is 300 l/ha.

As is known in the art, the desired application rate may be based on a number of different factors, which may include but are not limited to orchard history, pollination effectiveness, age of plant, condition of roots, shading of the fruitlets, quality of the soil, adequacy of the nutrients being supplied to the plant, amount of bloom, fruit clustering, weather conditions, and variety of fruit.

Time of application of the first and/or second dose may be determined based on meteorological data affecting the fruit bearing plant. The first application of the photosynthesis inhibiting fruit thinning agent may be applied at a fruiting stage of, preferably 8 to 30 mm, especially preferably 8 to 17 mm, especially preferably 10 to 12 mm, fruiting stage or later. In one embodiment, the first dose is applied when the fruit size is 6-8 mm. In another embodiment, the first dose is applied when the fruit size is 8-10 mm. In one embodiment, the second dose, if needed, is applied when the fruit size is 12-14 mm. According to an embodiment, the fruit thinning agent may be applied during the fruiting stage BBCH69-BBCH72, or during the fruiting stage BBCH71-BBCH72. In one embodiment, the first and/or second dose is applied in the morning. In another embodiment the first and/or second dose is applied in the afternoon. In yet another embodiment, the first and/or second dose is applied in the evening. This procedure permits the selective thinning of fruit after observing the actual cropping level up to as late of a date as possible.

In one embodiment, the amount of the first dose may be determined based on the photosynthetic activity of the fruit bearing plant. In one embodiment, the time of application of the first dose may also be determined based on the photosynthetic activity of the fruit bearing plant.

After the first application of the fruit thinning agent, the efficacy of such application should be assessed. In one embodiment, the application of the first dose has an effect on fruit thinning. In one embodiment, application of the first dose has a strong effect on fruit thinning. In another embodiment, application of the first dose has a moderate effect on fruit thinning. In another embodiment, application of the first dose has a low effect on fruit thinning. In another embodiment, application of the first dose has no effect on fruit thinning.

The term “strong effect” can be interpreted to mean that the fruit bearing plant responds well to the fruit thinning agent and a high percentage of the anticipated number of fruit to be dropped was achieved. The term “minimal effect” or “low effect” can be interpreted to mean that the fruit bearing plant does not respond well to the fruit thinning agent and only a low percentage of the anticipated number of fruit to be dropped was achieved. The term “medium effect” can be interpreted to mean that the fruit bearing plant responds to the fruit thinning agent and the anticipated number of fruit to be dropped may or may not have been achieved. According to an embodiment, “strong effect” means having a desirable fruit drop of greater than 50%, “medium effect” means having a desirable fruit drop of 20%-50% and “low effect” means having a desirable fruit drop of less than 20%.

In one embodiment, application of the first dose is effective in reducing number of fruits per trunk cross-sectional area, number of flower clusters per tree, fruits per tree, and/or crop load. In one embodiment, application of the first dose is effective in reducing the number of fruits per tree by 5%-100% comparing to the number of fruits per tree on an untreated tree. In one embodiment, application of the first dose is effective in reducing the number of fruits per tree by 20%-80% comparing to the number of fruits per tree on an untreated tree. In another embodiment, application of the first dose is effective in reducing the number of fruits per tree by 20%-50% comparing to the number of fruits per tree on an untreated tree. In yet another embodiment, application of the first dose is effective in reducing the number of fruits per tree by 30% or 40% comparing to the number of fruits per tree on an untreated tree.

As there is a large number of factors affecting the development of a fruit bearing plant, and as such the growth of the fruit on the plant, the efficacy of the fruit thinning agent is nearly impossible to accurately assess. Furthermore, fruits generally do not show any visible sign until an average of 14 days after the first application. It would be very difficult to assess if the first dose of the photosynthesis inhibiting fruit thinning agent was sufficient in that will the expected number of fruits drop from the plant, and if not how much fruit thinning agent should be applied in a second treatment.

The evaluation in step S105 may comprise at least two steps. In a first step, the photosynthetic activity of the fruit bearing plant may be measured. The photosynthesis process is the process by which organisms convert solar energy to chemical energy. A photosynthetic system includes a photosystem whose primary function is to absorb the sunlight and the transfer of energy and electrons. The photosystem comprises two important protein complexes, namely photosystems I and II (PSI and PSII, respectively). The activity of at least one of PSI and PSII may be measured. Methods and devices for measuring the photosynthetic activity as described in U.S. Pat. No. 6,100,093, which is hereby incorporated by reference. This reference describes determining a relaxation parameter for a PSI for a given crop, through the steps of (a) bringing at least some of a number of types of molecules which are located on the donor side of PSI into an oxidized state; (b) allowing at least some of the oxidized molecules to be reduced; and (c) determining the relaxation parameter, which contains information on the speed of the reduction, wherein step (c) comprises at least the following sub steps: (1) measurement of absorption of light in a predetermined wavelength region by the oxidized molecules in the crop during the reduction, and (2) calculation of the rate of change in the measured absorption as a function of time, the rate parameter being the relaxation parameter. This reference also describes an apparatus for determining the photosynthetic activity. The apparatus comprises (a) means for bringing at least some of a number of types of molecules which are located on the donor side of PSI into an oxidized state; (b) means for allowing at least some of the oxidized molecules to be reduced; and (c) means for determining a relaxation parameter which contains information on the speed of the reduction, wherein the means for determining the relaxation parameter comprises at least (1) means for measurement of absorption of light in a predetermined wavelength region by the oxidized molecules in the crop during the reduction, and (2) means for calculation of the rate parameter which contains information on the speed of a change in the measured absorption as a function of time. The determined rate parameter can be compared to a relaxation parameter or range thereof in a database to determine the photosynthetic activity.

Photosynthesis activity following the application of a photosynthesis inhibiting fruit thinning agent may also be determined using a Minimum Lethal Herbicide Dose (MLHD) meter. One type of MLHD meter available is a Plant Photosynthesis Meter (PPM-Meter). This type measures the fluorescence of the plant tissue under investigation, on a scale of 0 (no photosynthesis at all) to 80 (completely normal photosynthetic activity). A reading lower than 20 predicts that a plant is likely to die if it has been treated with a photosynthesis inhibiting agent. Values between 70-80 indicate healthy plants.

A second type of MLHD meter is a Photosystem I (PSI) meter. The leaf is clipped into the meter. This measures absorption of light by plant tissue, on a scale of 0 (no damage to PSI at all, normal photosynthetic activity) to 100 (all photosystems I are blocked, no photosynthetic activity). Ambient light does not affect the reading when the plant tissue is clipped into the meter. A reading higher than 80 indicates that the plant tissue is likely to die if it has been treated with a photosynthesis inhibiting agent 2 days before or more. According to an embodiment, a high PSI reading is defined as a reading of >50, and a low PSI reading is defined as <33⅓. In another embodiment, a high PSI reading is defined as a reading of >65, and a low PSI reading is defined as <50. In another embodiment, a high PSI reading is defined as a reading of >50, and a low PSI reading is defined as <50.

Both of these MLHD meter types are described in the MLHD manual (Opticrop/Plant Research International, English version 2.0, 2004), the contents of which are hereby incorporated by reference.

Another method of measuring photosynthetic activity is by measuring CO₂ exchange. Non-limiting examples of devices used for such methods are disclosed in Long et al. (1996), the contents of which are hereby incorporated by reference. Many such devices encompass a leaf in a chamber and measure the CO₂ uptake using non-dispersive infrared gas analysis of the gas in the chamber, although methods exist of measuring CO₂ uptake without encompassing the leaf in a chamber.

Another method of measuring photosynthetic activity is by using photoacoustic spectroscopy combined with confocal scanning microscopy. Non-limiting examples of devices used for such methods are disclosed in Kojima et al. (2000), the contents of which are hereby incorporated by reference. In one such device, the sample leaf is placed in a photoacoustic cell. Modulated light, mechanically modulated by a light chopper, and non-modulated light is combined in a bifurcated fiber optic light guide and projected onto the leaf. The leaf is pressed against a hole in the photoacoustic cell, where the hole comprise a microphone. The leaf is periodically heated by the periodic absorption of the modulated light, causing pressure in the chamber to oscillate at the chopping frequency, which in turn causes diaphragm deflections which generate a voltage across a resistor installed outside of the microphone. The voltage generated will vary with the absorption.

One skilled in the art will recognize that any methods or devices that can measure the photosynthetic activity of the fruit bearing plant may be used in accordance with the present subject matter. Methods of measuring photosynthetic activity may also include but are not limited to measuring light absorption rate, measuring the rate of CO₂ uptake, measuring the O₂ production, measuring the production of carbohydrates and measuring the increase in dry mass.

According to some embodiments, the photosynthetic activity of the fruit bearing plant may be measured for a first time approximately 4-6 hours after the first application. Subsequent measurements of the photosynthetic activity may be taken at least once, or at least twice a day for a period of two, three, four, five or more days.

In a second step of evaluation step S105, the actual meteorological data from the time of the first application may be obtained. As mentioned with regards to step S101, a multi-day weather forecast of meteorological data is used as a parameter in determining the dosage rate of fruit thinning agent for the first application. In step S105, the actual meteorological data is evaluated as forecasts are generally inaccurate, especially irradiation data, and as such the efficacy of the first application may not be very high.

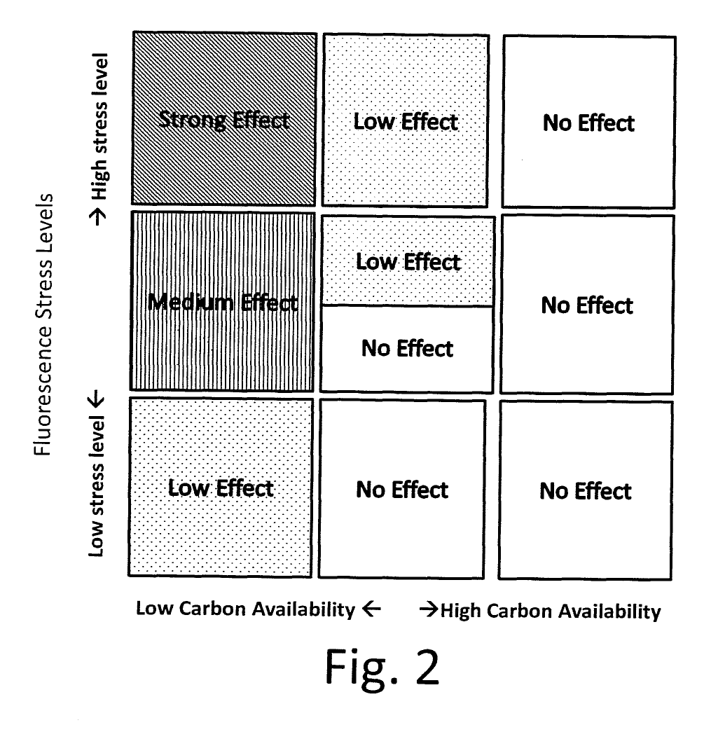

The data obtained from the evaluation step is shown in FIG. 2. As can be seen in FIG. 2, it has been shown that when the measured photosynthesis levels are low (i.e. the fruit bearing plant is under high stress) and the levels of available carbohydrates are reduced, the photosynthesis inhibiting fruit thinning agent had a strong effect on the fruit bearing plant. Conversely, when the measured photosynthesis levels are high (i.e. the fruit bearing plant is under low stress) and the levels of available carbohydrates are high, the photosynthesis inhibiting thinning agent had a minimal effect on the fruit bearing plant. One skilled in the art would recognize that levels of photosynthetic activity are directly related to the type of fruit bearing plant. According to one example, photosynthetic activity levels above 15-22 μmol*m⁻²*s⁻¹ are considered high levels of activity and levels below 15-22 μmol*m⁻²*s⁻¹ are considered low levels of activity.

Further, it has been shown that the fruit thinning agent seems to have minimal or low effect on the fruit bearing plant when measured photosynthesis levels are high, regardless of the amount of carbohydrates available to the plant. Also, when high levels of carbohydrates are available to the plant, the fruit thinning agent seems to have minimal or no effect, regardless of the level of measured photosynthesis levels. As can be seen in FIG. 2, the fruit thinning agent may have a medium effect on the fruit bearing plant under certain conditions.

A carbohydrate balance model, namely the MaluSim model, has been described in Robinson, T. L. and A. N. Lakso, New York Fruit Quarterly Vol. 19(1): 15-20 (2011). The Malusim model calculates dry matter production and consumption using primary photosynthesis level and leaf area of the fruit bearing plant. Respiration from all the organs of the tree together is calculated in Malusim and delivers dry matter consumption. The respiration for the fruits depends heavily on the temperature, but also on the number of fruits and the fruit dry weight (i.e. fruit size).

Meteorological data such as temperature and amount of available sunlight may be used to partially to determine the ability of the fruit bearing plant to withstand a chemical thinning process. For example, when there is high outside temperatures and there is limited amount of sunlight, fruit bearing plants may be responsive to chemical fruit thinning due to the reduced levels of available carbohydrates. With reduced levels of available carbohydrates fruit bearing plants tend to drop fruits more readily. On the other hand, when there is low outside temperatures and there is a high level of sunlight, fruit bearing plants may be less responsive to chemical fruit thinning due to the increased levels of available carbohydrates. High levels of available carbohydrates tend to make the fruit “stronger” in that the fruit bearing plants is less inclined to drop the fruit from the plant. One skilled in the art would know to appreciate that determination of “high temperature” and “low temperature” is based on the average temperature of the given day, including day time and night time temperatures for that day.

One skilled in the art would also know to appreciate that the terms “high temperature” and “low temperature” are relative due to multiple factors such as for example, type of fruit plant, size of the fruit, blooming intensity of the fruit, age of the wood or plant, type of wood or plant, crop load, flower bud quality, competition within clusters and canopy cover. Generally, low temperatures relate to temperatures below 20° C. and high temperatures relate to temperatures above 30° C. Further, one skilled in the art would know to appreciate that the terms “high level of sunlight” and “low level of sunlight” are relative due to multiple factors such as those listed hereinabove. Generally, there are high levels of sunlight when there is no or minimal amount of cloud cover and there are low levels of sunlight when there is a high amount of cloud cover.

In order to determine if a second application of the photosynthesis inhibiting fruit thinning agent is necessary, a second application determination step S107 is required. Step S107 may comprise two individual steps: (i) utilizing the evaluated information obtained in step S105 and (ii) obtaining impending meteorological data which may include but is not limited to a multi-day weather forecast. According to an embodiment, the multi-day forecast may include a period of time before and/or after the second application of the fruit thinning agent. For example, the weather forecast may include one to two days preceding the second application and/or one to two days after the second application.

According to an embodiment, the determination of whether a second application of the photosynthesis inhibiting fruit thinning agent is necessary is made based on measurement at a time after the application of the first dose of the photosynthetic activity of the fruit bearing plant. In one embodiment, time of application of the second dose, if needed, is also determined based on the photosynthetic activity of the fruit bearing plant. In one embodiment, the amount of the second dose, if needed, is also determined based on the photosynthetic activity of the fruit bearing plant.

According to an embodiment, the photosynthetic activity includes at least one of PSI activity and PSII activity. According to another embodiment, the photosynthetic activity is measured for a period of at least 2-5 days after applying the first dose. According to another embodiment, the photosynthetic activity is measured for a first time 4-6 hours after applying the first dose.

According to an embodiment, the photosynthetic activity is measured by a MLHD meter, by measuring CO₂ exchange, by photoacoustic spectroscopy combined with confocal scanning microscopy, by measuring light absorption rate, measuring the rate of CO₂ uptake, by measuring the O₂ production, by measuring the production of carbohydrates, or by measuring the increase in dry mass. According to another embodiment, the photosynthetic activity is measured by a MLHD meter which is a PSI meter. According to another embodiment, following the first dose of the photosynthesis inhibiting fruit thinning agent, i) if the PSI meter measurement is low, a second dose of the photosynthesis inhibiting fruit thinning agent is applied; ii) if the PSI meter measurement is high, a second dose of the photosynthesis inhibiting fruit thinning agent is not applied; and iii) if the PSI meter measurement is neither high nor low, meteorological data is also used to determine if a second dose is to be applied.

According to an embodiment, multiple PSI meter measurements are made, and an average or weighted average of the PSI meter measurements is used to determine whether a second dose is to be applied, or if meteorological data is also used.

According to an embodiment, the meteorological data is used to determine if the weather conditions are favorable for a second application. Weather conditions may be considered favorable when fruit bearing plants are responsive to the fruit thinning agents. For example, when outside temperatures are relatively high and available sunlight is low, plants may be more responsive to the thinning agents. On the other hand, when outside temperatures are relatively low and available sunlight is high, plants may be less responsive or not responsive at all to the thinning agents.

According to an embodiment, meteorological data includes at least one of daytime temperatures, nighttime temperatures, amount of sunlight, cloud cover and humidity.

According to another embodiment, the meteorological data from the time of the first application comprises meteorological data from 1-2 days prior to the application and/or 1-2 days after the application. According to another embodiment, the method further comprises obtaining a multi-day weather forecast preceding the application of the first dose.

In an embodiment, the amount of the second dose is calculated.

In an embodiment, if the results of the evaluation step determined that the first application had a “strong effect”, and the impending weather conditions are favorable for fruit thinning, a second application of the fruit thinning agent may be applied at a low dose. If the impending weather conditions are not favorable or are moderately favorable, no second application of the fruit thinning agent is applied.

In an embodiment, if the results of the evaluation step determined that the first application had “no effect”, and the impending weather conditions are favorable or moderately favorable for fruit thinning, a second application of the fruit thinning agent may be applied at a high or medium dose. If the impending weather conditions are not favorable, a second application of the fruit thinning agent may be applied at a medium dose.

In an embodiment, if the results of the evaluation step determined that the first application had a “low effect”, and the impending weather conditions are favorable for fruit thinning, a second application of the fruit thinning agent may be applied at a high dose or a medium dose. If the impending weather conditions are moderately favorable for fruit thinning, a second application of the fruit thinning agent may be applied at a medium dose. If the weather conditions are not favorable, a second application of the fruit thinning agent may be applied at a low dose.

In an embodiment, if the results of the evaluation step determined that the first application had a “medium effect”, and the impending weather conditions are favorable for fruit thinning, a second application of the fruit thinning agent may be applied at a high dose or a medium dose. If the impending weather conditions are moderately favorable for fruit thinning, a second application of the fruit thinning agent may be applied at a medium dose. If the weather conditions are not favorable, a second application of the fruit thinning agent may be applied at a low dose.

Impending weather conditions are considered “favorable” for fruit thinning when a higher dose of fruit thinning agent is needed to achieve the same fruit thinning effect, i.e. when there is high radiation and low temperature. Radiation level may be affected by a variety of factors, including, but not limited to, cloud coverage, time of year, altitude, physical features of the land, and proximity to the equator.

With regards to the second application, the term “high dose” may refer to application rates of approximately 1.8 to 2.6 kg/ha, preferably approximately 2 to 2.4 kg/ha and more preferably approximately 2.2 kg/ha. The term “medium dose” may refer to application rates of approximately 1.25 to 2.05 kg/ha, preferably approximately 1.45 to 1.85 kg/ha and more preferably approximately 1.65 kg/ha. The term “low dose” may refer to application rates of approximately 0.7 to 1.5 kg/ha, preferably approximately 0.9 to 1.3 kg/ha and more preferably approximately 1.1 kg/ha.

In accordance with the results of determination step S107, second application dosage S109 may be applied, if necessary. The second application may be applied at least 5 days, 6 days 7 days or more after the first application.

According to an embodiment, the photosynthesis inhibiting chemical thinning agent is selected from the group consisting of metamitron, chloroxuron, fluometuron, cyanazine, terbacil, simazine, propazine, terbutryn, dipropetryn, metribuzin, diuron, and bentazon.

According to an embodiment, the photosynthesis inhibiting chemical thinning agent is metamitron.

In one embodiment, the amount of the second dose is 0.2-7.5 kg/ha. In one embodiment, the amount of the second dose is 0.5-2.5 kg/ha. In one embodiment, the amount of the second dose is 0.5-2.2 kg/ha. In one embodiment, the amount of the second dose is 0.75-2.5 kg/ha. In one embodiment, the amount of the second dose is 1.1-2.2 kg/ha. In one embodiment, the amount of the second dose is 1.1 kg/ha. In one embodiment, the amount of the second dose is 1.65 kg/ha. In one embodiment, the amount of the second dose is 2.2 kg/ha.

According to an embodiment, the first or second dose of chloroxuron is 2-7.5 kg/ha. According to another embodiment, the first or second dose of fluometuron is 1.12-2.25 kg/ha. According to another embodiment, the first or second dose of cyanazine is 0.25-2.2 kg/ha. According to another embodiment, the first or second dose of terbacil is 1-4.5 kg/ha. According to another embodiment, the first or second dose of simazine is 1.1-2.2 kg/ha. According to another embodiment, the first or second dose of propazine is 0.2-2 kg/ha. According to another embodiment, the first or second dose of terbutryn is 0.2-3 kg/ha. According to another embodiment, the first or second dose of dipropetryn is 1.25-3.5 kg/ha. According to another embodiment, the first or second dose of metribuzin is 1.12-2.25 kg/ha. According to another embodiment, the first or second dose of diuron is 1.1-2.2 kg/ha. According to another embodiment, the first or second dose of bentazon is 1.1-1.65 kg/ha. In another embodiment, the first or second dose of any of these photosynthesis inhibiting fruit thinning agents is 0.2-7.5 kg/ha.

According to an embodiment, metamitron is used as the photosynthesis inhibiting chemical thinning agent in methods of the present subject matter. Metamitron influences the transport of electrons in the PSII system, leading to reducing the transfer from light energy to chemical energy. The reduced production of carbohydrates at the same demand level will cause fruit to drop.

According to an embodiment, photosynthesis inhibiting fruit thinning agents according to embodiments of the present subject matter may be used in conjunction with other fruit thinning agents such as for example, ammonium thiosulfate, naphthaleneacetamide, naphthalene acetic acid, carbaryl, 6-benzyladenine, 6-benzyaminepurine and ethephon.

The methods according to embodiments of the present subject matter may be suitable for fruit thinning fruit bearing trees, particularly in pome fruit trees. Examples of pome fruit may include but are not limited to apples, pears and quince. Varieties of apples may include but are not limited to Boskoop, Braeburn, Cox Orange, Elstar, Gala, Gloster, Golden Delicious, Fuji, Jamba, James Grieve, Jonagold, Jonathan, Lobo, Mcintosh, Red Delicious and Spartan. Varieties of pears may include but are not limited to Asian pears, European pears and Bartlett. There may also be suitability for olive, pistachios, kiwi fruit, grapevines or citrus crop.

In one embodiment, the subject invention also provides a method of determining whether a dose of a photosynthesis inhibiting fruit thinning agent is required to be applied to a fruit bearing plant to thin fruit on the plant comprising: (i) obtaining meteorological data affecting the fruit bearing plant and/or a measurement of photosynthetic activity of the fruit bearing plant, and (ii) determining whether a dose of a photosynthesis inhibiting fruit thinning agent is required based on the meteorological data and/or photosynthetic activity obtained in step (i).

In a preferred embodiment, the meteorological data is obtained for the week before the planned application of the dose of photosynthesis inhibiting fruit thinning agent. In another preferred embodiment, the meteorological data comprises temperature and radiation. In another preferred embodiment, the meteorological data is interpreted using the Brevis Index. Other types of meteorological data, periods of time for which the meteorological data is obtained, and methods of interpretation of the obtained meteorological data are described above. Different types of measurements of photosynthetic activity of the fruit bearing plant and their methods of interpretation are also described above.

It will be appreciated that the methods and processes described hereinabove can be implemented in hardware, hardware programmed by software, software instruction stored on a non-transitory computer readable medium or a combination of the above. For example, a method for fruit thinning a fruit bearing plant can be implemented, for example, using a processor configured to execute a sequence of programmed instructions stored on a non-transitory computer readable medium. For example, the processor can include, but not be limited to, a personal computer, workstation, tablet, cellular device or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, Lab VIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the methods and processes can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The methods or processes described hereinabove can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of chemical fruit thinning and/or computer programming arts.

For the foregoing embodiments, each embodiment disclosed herein is contemplated as being applicable to each of the other disclosed embodiments.

### Example 1: Using Photosynthetic Data and Meteorological Data to Determine if, and how Large, a Second Dose of Metamitron should be Used

A formulation of metamitron in the form of a soluble granule was diluted to the desired concentration with water. The following concentrations were prepared:
1.1 Kg/ha metamitron (low dosage)
1.65 Kg/ha metamitron (medium dosage)
2.2 Kg/ha metamitron (high dosage)

The experiments were conducted on the Golden Delicious variety of apples in Germany and Italy. The first application of metamitron was applied to the fruit trees in May when the fruit was at fruiting stage BBCH69-BBCH72. The second application of metamitron was applied, if applicable, five days after the first application.

Local meteorological data was obtained from local weather stations. The meteorological data was inputted into the MaluSim Carbon Balance Model of Lakso (described at http://newa.nrcc.cornell.edu/apple_thin_help.html, the contents of which are hereby incorporated by reference) in order to obtain the level of carbohydrates available in the fruit tree.

The thinning effect is calculated by comparing the treated fruit trees with the untreated control as follows:

$$\% control observed = \frac{\begin{matrix}fruit dropped in untreated control - \\ fruit dropped in treated tree\end{matrix}}{fruit dropped in untreated control} * 100$$

The following results were obtained:

TABLE 1
Fruit Thinning Efficacy - Italy

| | | | | Predicted | | | |
|---|---|---|---|---|---|---|---|
| Dose of 1^{st} | Carbohydrate | | Dose of 2^{nd} | Carbohydrate | | Optimal | |
| Application | Level @ 1^{st} | Photosynthetic | Application | Level @ 2^{nd} | Fruit Load | Fruit | Thinning |
| (Kg/ha) | application | Activity levels | (Kg/ha) | application | (fruits/tcsa) | Load | Effect (%) |
| 1.65 | High | Low | 0 | High | 12.33 | 9 | 31.27 |
| 1.65 | High | Low | 1.1 | High | 12.30 | 9 | 31.39 |
| 1.65 | High | Low | 2.2 | High | 9.58 | 9 | 46.57 |
| 2.2 | High | Low | 0 | High | 12.67 | 9 | 29.38 |
| 2.2 | High | Low | 2.2 | High | 9.37 | 9 | 47.75 |

*tcsa = trunk cross-sectional area

TABLE 2
Fruit Thinning Efficacy - Germany

| | | | | Predicted | | | |
|---|---|---|---|---|---|---|---|
| Dose of 1^{st} | Carbohydrate | | Dose of 2^{nd} | Carbohydrate | | Optimal | |
| Application | Level @ 1^{st} | Photosynthetic | Application | Level @ 2^{nd} | Fruit Load | Fruit | Thinning |
| (Kg/ha) | application | Activity levels | (Kg/ha) | application | (fruits/tcsa) | Load | Effect (%) |
| 1.65 | Low | Low | 0 | High | 11.20 | 6 | 33.2 |
| 1.65 | Low | Low | 1.1 | High | 11.42 | 6 | 31.8 |
| 1.65 | Low | Low | 2.2 | High | 6.83 | 6 | 59.3 |
| 2.2 | Low | Low | 0 | High | 11.44 | 6 | 31.8 |
| 2.2 | Low | Low | 1.1 | High | 11.40 | 6 | 32.0 |
| 2.2 | Low | Low | 1.65 | High | 11.98 | 6 | 28.5 |
| 2.2 | Low | Low | 2.2 | High | 8.07 | 6 | 51.8 |

*tcsa = trunk cross-sectional area

As can be seen in Tables 1-2, based on the carbohydrate levels (meteorological data) at the time of the first application of the fruit thinning agent and the photosynthetic activity levels of the fruit bearing tree after the application of the fruit thinning agent, the first application of the fruit thinning agent had no effect on the fruit bearing tree. Based on this and on the predicted meteorological data for the time of the second application, the second application should be applied at a high dose in order to effectively thin the fruit bearing tree. As can be seen in Tables 1-2, the recommended higher dose of 2.2 Kg/ha of the fruit thinning agent had a better effect than those of the lower doses. No over-thinning was observed.

### Example 2: Using Only Photosynthetic Data to Determine if a Second Dose of Metamitron should be Used

This method was tested with all relevant metamitron trials applied to apple and pear trees from 2009-2012, and compared to results using the method described in Example 1. Concentrations of metamitron used were 1.1 kg/ha, 2.2 kg/ha, and 4.4 kg/ha

Two PSI meter readings, on a scale of 0-100, were taken, prior to a potential second application. The first measurements (P₁) were taken between 2-4 days after application (the 8-10 mm stage), and the second measurements (P₂) were taken shortly before the 12-14 mm stage.

The relevant calculation used was P₁+2*P₂=Pₜ.

The resulting data was interpreted via two different methods. One method of interpreting the data, using three classes, was as follows:
If Pₜ<100: a second application was required.
If Pₜ>150: no second application was required.
If 100<Pₜ<150: more information, such as meteorological data, was required.

A second method of interpreting the data, using two classes, was as follows:
If Pₜ<150: a second application was required.
If Pₜ>150: no second application was required.

The resulting calculations were compared to the results of the method used in Example 1. The results are shown in Tables 3-4. “Yes” indicates a result in agreement with the determination made by the method used in Example 1, whereas “No” indicates a result that was not in agreement with the determination made by the method used in Example 1.

TABLE 3
Using 2 classes to make projections

| | | Apples | | Pears | |
|---|---|---|---|---|---|
| | | (n = 17) | | (n = 31) | |
| Pₜ | | Yes | No | Yes | No |
| <150 | Second application req'd | 9 | 3 | 11 | 8 |
| >150 | No second application req'd | 5 | 0 | 12 | 0 |

TABLE 4
Using 3 classes to make projections

| | | Apples | | Pears | |
|---|---|---|---|---|---|
| | | (n = 17) | | (n = 31) | |
| Pₜ | | Yes | No | Yes | No |
| <100 | Second application req'd | 4 | 0 | 7 | 1 |
| 100-150 | More information req'd | 8 | | 11 | |
| >150 | No second application req'd | 5 | 0 | 12 | 0 |

The results demonstrate the feasibility of determining whether a second application of photosynthesis inhibiting fruit thinning agent using only photosynthetic activity data.

### Example 3: Using Meteorological Data to Determine when and how Large a First Dose of Metamitron should be Used and Using Photosynthetic Data and Meteorological Data to Determine if and how Large a Second Dose of Metamitron should be Used

A formulation of metamitron in the form of a soluble granule was diluted to the desired concentration with water. The following concentrations were prepared:
1.1 Kg/ha metamitron (low dosage)
1.65 Kg/ha metamitron (medium dosage)
2.2 Kg/ha metamitron (high dosage)

Local meteorological data is obtained from local weather stations. In particular, the temperature and radiation data is obtained. Temperature and radiation are the basic parameters used for calculating CHO balance using the Brevis Index.

Meteorological data, including temperature and radiation data, from one week prior to the first application to one week after the first application is obtained. Preferably, meteorological data is obtained when fruit size is 8-10 mm. The meteorological data, including temperature and radiation data, is used to calculate the Brevis Index (BI1). Based on BI1, the timing and amount of the first application of metamitron is determined, and the first application of metamitron is applied accordingly to fruit trees.

Meteorological data, including temperature and radiation data, is obtained for the period from the first application to one week after the second application. The meteorological data, including temperature and radiation data, is used to calculate the Brevis Index (BI2). Photosynthetic data is obtained for the period from the first application to the second application. The photosynthetic data may be obtained and interpreted using Example 2.

Based on BI2 and the photosynthetic data, whether a second application of metamitron is needed is determined. If needed, the amount of the second application of metamitron is determined, and the second application of metamitron is applied accordingly to fruit trees.

The thinning effect is calculated by comparing treated fruit trees with the untreated controls as follows:

$$\% control observed = \frac{\begin{matrix}fruit dropped in untreated control - \\ fruit dropped in treated tree\end{matrix}}{fruit dropped in untreated control} \times 100$$

Application of Brevis in accordance with method described above yields a thinning effect of 20% to 60%. Application of Brevis in accordance with method described above yields a fruit load of 6-13 fruits/trunk cross-sectional area.

### Example 4: Algorithm of the Brevis Index

An algorithm form the Brevis Index was developed. The algorithm for calculating the Brevis Index may be improved as more data become available, particularly data in different agricultural regions, including results from the following trials:

TREATMENTS ‘RATE TRIAL’

Time of application and rate
Kg/ha Brevis ®

| | TREATMENT | (A) 8 mm Ø | (B) 14 mm Ø |
|---|---|---|---|
| 1 | CONTROL | — | — |
| 2 | BREVIS 1.1 (A) 0 (B) | 1.1 | — |
| 3 | BREVIS 1.65 (A) 0 (B) | 1.65 | — |
| 4 | BREVIS 2.2 (A) 0 (B) | 2.2 | — |
| 5 | BREVIS 0 (A) 2.2 (B) | — | 2.2 |

TREATMENTS ‘TIMING TRIAL’

| | | Time of application and rate Kg/ha Brevis ® | | | | | |
|---|---|---|---|---|---|---|---|
| | | 7 mm Ø | 9 mm Ø | 11 mm Ø | 13 mm Ø | 15 mm Ø | 17 mm |
| | Treatment | (6-8 mm) | (8-10 mm) | (10-12 mm) | (12-14 mm) | (14-16 mm) | (16-18 m [symbol] |
| 1 | CONTROL | — | — | — | — | — | — |
| 2 | | 1.65 | | | | | |
| 3 | | | 1.65 | | | | |
| 4 | BREVS | | | 1.65 | | | |
| 5 | 1 APLIC. × 1.65 | | | | 1.65 | | |
| 6 | | | | | | 1.65 | |
| 7 | | | | | | | 1.65 |

[symbol]

indicates data missing or illegible when filed

BI1 was calculated using temperature and radiation data during a period prior to the application of the first dose. BI1 indicates the % of fruit removed compared to untreated plant per kg/ha of applied Brevis.

BI2 was calculated using temperature and radiation data during a period prior to the application of the second dose. BI12 indicates the % of fruit removed compared to untreated plant per kg/ha of applied Brevis.

While the present subject matter has been shown and described with reference to preferred embodiments thereof, it will be understood by those skilled in the art that many alternatives, modifications and variations may be made thereto without departing from the spirit and scope thereof. Accordingly, it is intended to embrace all such alternatives, modifications, and variations that fall within the spirit and broad scope of the appended claims. Every embodiment and feature described in the application should be understood to be interchangeable and combinable with every with embodiment contained within.

All publications, patents and patent applications mentioned in this specification are herein incorporated in their entirety by reference into the specification, to the same extent as if each individual publication, patent or patent application was specifically and individually indicated to be incorporated herein by reference.

### REFERENCES

U.S. Pat. No. 6,100,093, issued to Van Kooten et al., Aug. 8, 2000
U.S. Pat. No. 8,826,587, issued to Baur et al., Sep. 9, 2014
Apple Carbohydrate Thinning Model, http://newa.nrcc.cornell.edu/apple_thin_help.html, retrieved Jul. 16, 2015
Byers et al. (1990), Apple Thinning by Photosynthetic Inhibition, J. Amer. Soc. Hort. Sci, 115(1):14-19
Federal Biological Research Centre for Agriculture and Forestry (2001), “Growth stages of mono- and dicotyledonous plants”, BBCH Monograph, 2^{nd} ed.
Kojima et al. (2000), Photosynthetic Activity Measurement of Plants Using
Photoacoustic Spectroscopy Combined with Confocal Scanning Microscopy, IEICE Trans. Electron., Vol. E83-C(7), July 2000
Long et al. (1996), Measurement of leaf and canopy photosynthetic CO2 exchange in the field, Jour. Exp. Bot, 47(304:1629-1642
Robinson, T. L. and A. N. Lakso, Advances in predicting chemical thinning response of apple using a carbohydrate model, New York Fruit Quarterly Vol. 19(1): 15-20 (2011)

1-21. (canceled)

22. A method of fruit thinning a fruit bearing plant comprising:
(a) determining the amount of a first dose of photosynthesis inhibiting fruit thinning agent based on at least one parameter selected from the group consisting of orchard history, fruit variety, fruit size, fruit clustering, competition within clusters, pollination effectiveness, blooming intensity, quality of flower buds, crop load, age of plant, level of vigor, condition of roots, quality of the soil, adequacy of the nutrients being supplied to the plant, shading of the fruitlets, presence of canopy cover, and meteorological data affecting the fruit bearing plant,
(b) determining the time of application of the amount of the first dose of photosynthesis inhibiting fruit thinning agent determined in (a) based on at least one parameter selected from the group consisting of orchard history, fruit variety, fruit size, fruit clustering, competition within clusters, pollination effectiveness, blooming intensity, quality of flower buds, crop load, age of plant, level of vigor, condition of roots, quality of the soil, adequacy of the nutrients being supplied to the plant, shading of the fruitlets, presence of canopy cover, and meteorological data affecting the fruit bearing plant, and
(c) applying the amount of the first dose of photosynthesis inhibiting fruit thinning agent determined in (a) at the time determined in (b) thereby fruit thinning the fruit bearing plant.

23. The method of claim 1, wherein the amount of the first dose of photosynthesis inhibiting fruit thinning agent is determined based on orchard history, fruit variety, fruit size, fruit clustering, competition within clusters, pollination effectiveness, blooming intensity, quality of flower buds, crop load, age of plant, level of vigor, condition of roots, quality of the soil, adequacy of the nutrients being supplied to the plant, shading of the fruitlets, and presence of canopy cover.

24. The method of claim 1, wherein the amount of the first dose of photosynthesis inhibiting fruit thinning agent is determined to be 0.05 kg/ha to 4 kg/ha.

25. The method of claim 1, wherein the amount of the first dose of photosynthesis inhibiting fruit thinning agent is determined to be 1.65 kg/ha or 2.2 kg/ha.

26. The method of claim 1, wherein the time of application of the photosynthesis inhibiting fruit thinning agent is determined based on fruit type, fruit size, and/or the meteorological data affecting the fruit bearing plant.

27. The method of claim 5, wherein the meteorological data includes at least one of daytime temperatures, nighttime temperatures, amount of sunlight, cloud cover, humidity, average nighttime temperature, maximum daily temperature, minimum daily temperature, and daily radiation.

28. The method of claim 6, wherein the meteorological data includes average nighttime temperature and average daily radiation.

29. The method of claim 6, wherein:
a) the meteorological data includes a multi-day forecast of nighttime temperature for a period of time before and after the application of the photosynthesis inhibiting fruit thinning agent, and/or
b) the meteorological data includes a multi-day forecast of radiation for a period of time after the application of the photosynthesis inhibiting fruit thinning agent.

30. The method of claim 6, wherein:
a) the meteorological data includes a multi-day forecast of nighttime temperature, wherein the multi-day forecast includes a weather forecast of 5 days prior to the application of the photosynthesis inhibiting fruit thinning agent and/or 2 days after the application of the photosynthesis inhibiting fruit thinning agent, and/or
b) the meteorological data includes a multi-day forecast of radiation, wherein the multi-day forecast includes a forecast of 2 days after the application of the photosynthesis inhibiting fruit thinning agent.

31. The method of claim 1, wherein the first dose of photosynthesis inhibiting fruit thinning agent is applied when fruit size is 6-8 mm, 8-17 mm or 8-30 mm.

32. The method of claim 1, wherein the method further comprises (i) determining whether an amount of a second dose of the photosynthesis inhibiting fruit thinning agent needs to be applied, and if needed, (ii) determining the amount of the second dose based on meteorological data affecting the fruit bearing plant and (iii) applying the determined amount of second dose of the photosynthesis inhibiting fruit thinning agent to the fruit bearing plant, thereby fruit thinning the fruit bearing plant.

33. The method of claim 11, wherein:
a) the meteorological data includes average nighttime temperature, maximum daily temperature, minimum daily temperature, and/or daily radiation,
b) the amount of the second dose of the photosynthesis inhibiting fruit thinning agent is determined to be 0.2-7.5 kg/ha, and/or
c) the second dose is applied when the fruit size is 12-14 mm.

34. The method of claim 13, wherein the amount of the second dose is determined to be 1.1 kg/ha.

35. The method of claim 1, wherein the photosynthesis inhibiting fruit thinning agent is selected from the group consisting of metamitron, chloroxuron, fluometuron, cyanazine, terbacil, simazine, propazine, terbutryn, dipropetryn, metribuzin, diuron, and bentazon.

36. The method of claim 1, wherein photosynthesis inhibiting fruit thinning agent is metamitron.

37. The method of claim 1, wherein the fruit bearing plant is a pome fruit tree.

38. The method of claim 16, wherein the pome fruit tree is Golden Delicious apple tree, Gala apple tree, Fuji apple tree or Pink Lady apple tree.

39. A method of fruit thinning a fruit bearing plant, comprising:
(i) applying an amount of a first dose of a photosynthesis inhibiting fruit thinning agent to a fruit bearing plant;
(ii) determining whether a second dose of the photosynthesis inhibiting fruit thinning agent needs to be applied, and if so the calculated amount of such dose, based on measurement at a time after the application of the first dose of the photosynthetic activity of the fruit bearing plant; and
(iii) if needed, applying the calculated second dose of the photosynthesis inhibiting fruit thinning agent, thereby fruit thinning the fruit bearing plant.

40. The method of claim 18, wherein:
a) the second dose is determined to be needed and the second dose is applied when the fruit size is 12-14 mm, and/or
b) the amount of the second dose is 1.1 kg/ha.

41. The method of claim 18, wherein the photosynthesis inhibiting thinning agent is selected from the group consisting of metamitron, chloroxuron, fluometuron, cyanazine, terbacil, simazine, propazine, terbutryn, dipropetryn, metribuzin, diuron, and bentazon.
